(19) United States
(12) Patent Application Publication
(10) Pub. No.: US 2013/0007057 A1
(43) Pub. Date: Jan. 3, 2013

(54) AUTOMATIC IMAGE DISCOVERY AND RECOMMENDATION FOR DISPLAYED TELEVISION CONTENT

(75) Inventors: Dekai Li, Lawrenceville, GA (US); Ashwin Kashyap, Mountain View, CA (US); Jong Wook Kim, Torrance, CA (US); Ajith Kodakateri Hiyaveetil, Livonia, MI (US)

(73) Assignee: Thomson Licensing, Issyles-Moulineaux (FR)

(21) Appl. No.: 13/634,805

(22) PCT Filed: Apr. 29, 2011
(86) PCT No.: PCT/US11/00762

§ 371 Date: Sep. 13, 2012

Related U.S. Application Data
(60) Provisional application No. 61/343,547, filed on Apr. 30, 2010.

(51) Int. Cl. G06F 17/30

(52) U.S. Cl. 707/769; 707/E17.014; 707/E17.019

(57) ABSTRACT

A method and system are provided that can automatically discover related images and recommend them. It uses images that occur on the same page or are taken by the same photographer for image discovery. The system can also use semantic relatedness for filtering images. Sentiment analysis can also be used for image ranking and photographer ranking.

### CROSS REFERENCE TO RELATED APPLICATIONS

This application claims the benefit of U.S. Provisional Application Ser. No. 61/343,547 filed Apr. 30, 2010, which is incorporated by reference herein in its entirety.

### TECHNICAL FIELD

The present invention relates to recommendation systems and more specifically discovering and recommending images based on the closed caption of currently watched content.

### BACKGROUND

Television is a mass media. For the same channel, all audiences receive the same sequence of programs. There are little or no options for users to select different information related to the current program. After selecting a channel, users become passive. User interaction is limited to changing channel, displaying electronic program guide (EPG), etc. For some programs, users want to retrieve related information. For example, while watching a travel channel, many people want to see related images.

### SUMMARY

The present invention discloses a system that can automatically discover related images and recommend them. It uses images that occur on the same page or are taken by the same photographer for image discovery. The system can also use semantic relatedness for filtering images. Sentiment analysis can also be used for image ranking and photographer ranking.

In accordance with a one embodiment, a method is provided for performing automatic image discovery for displayed content. The method includes the steps of detecting the topic of the content being displayed extracting query terms based on the detected topic, discovering images based on the query terms, and displaying one or more the discover images.

In accordance with another embodiment, a system is provided for performing automatic image discovery for displayed content. The system includes a topic detection module, a keyword extraction module, an image discovery module, and a controller. The topic detection module is configured to detect a topic of the content being displayed. The keyword extraction module is configured to extract query terms from the topic of the content being displayed. The image discovery module is configured to discover images based on query terms; and the controller is configured to control the topic detection module, keyword extraction module, and image discovery module.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows a block diagram of an embodiment of a system for delivering content to a home or end user.

FIG. 2 presents a block diagram of a system that presents an arrangement of media servers, online social networks, and consuming devices for consuming media.

FIG. 3 shows a block diagram of an embodiment of a set top box/digital video recorder;

FIG. 4 shows a method chart for flowchart for determining if topics changed for a video asset;

FIG. 5 shows a block diagram of a configuration for receiving performing the functionality of FIG. 4; and

FIG. 6 is an embodiment of the display of returned images with a video broadcast.

### DETAILED DESCRIPTION

The present principles are directed recommendation systems and more specifically discovering and recommending images based on the closed caption of currently watched content.

It will thus be appreciated that those skilled in the art will be able to devise various arrangements that, although not explicitly described or shown herein, embody the present invention and are included within its spirit and scope.

All examples and conditional language recited herein are intended for pedagogical purposes to aid the reader in understanding the present invention and the concepts contributed by the inventor(s) to furthering the art, and are to be construed as being without limitation to such specifically recited examples and conditions.

Moreover, all statements herein reciting principles, aspects, and embodiments of the present invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present invention as defined by such claims resides in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

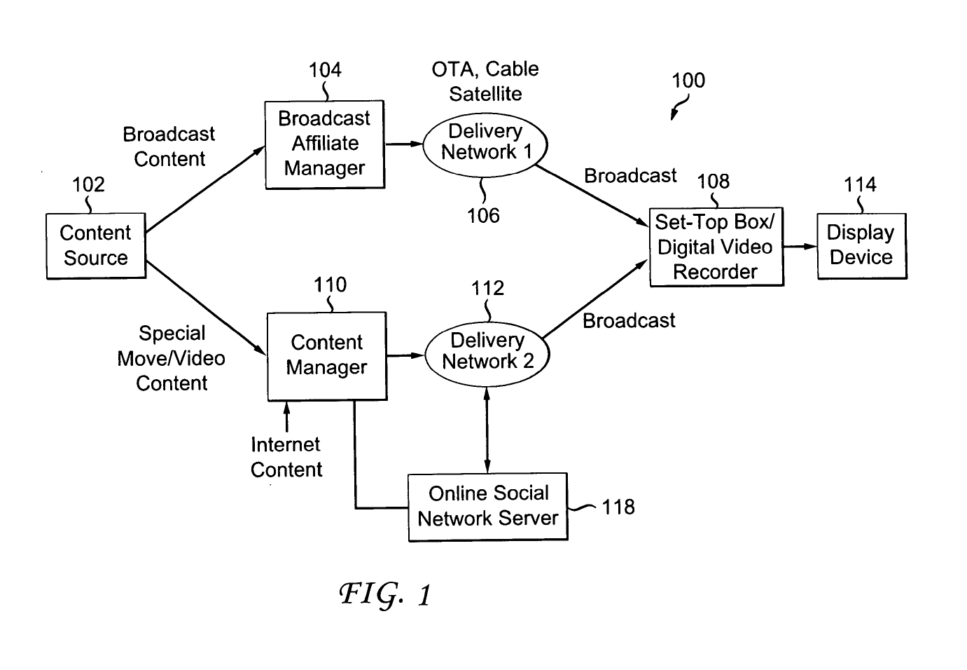

With reference to FIG. 1, a block diagram of an embodiment of a system 100 for delivering content to a home or end user is shown. The content originates from a content source 102, such as a movie studio or production house. The content can be supplied in at least one of two forms. One form can be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager can collect and store the content, and can schedule delivery of the content over a delivery network, shown as delivery network 1 (106). Delivery network 1 (106) can include satellite link transmission from a national center to one or more regional or local centers. Delivery network 1 (106) can also include local content delivery using local delivery systems such as over the air broadcast, satellite broadcast, cable broadcast or from an external network via IP. The locally delivered content is provided to a user's set top box/digital video recorder (DVR) 108 in a user's home, where the content will subsequently be included in the body of available content that can be searched by the user.

A second form of content is referred to as special content. Special content can include content delivered as premium viewing, pay-per-view, or other content not otherwise provided to the broadcast affiliate manager. In many cases, the special content can be content requested by the user. The special content can be delivered to a content manager 110. The content manager 110 can be a service provider, such as an Internet website, affiliated, for instance, with a content provider, broadcast service, or delivery network service. The content manager 110 can also incorporate Internet content into the delivery system, or explicitly into the search only such that content can be searched that has not yet been delivered to the user's set top box/digital video recorder 108. The content manager 110 can deliver the content to the user's set top box/digital video recorder 108 over a separate delivery network, delivery network 2 (112). Delivery network 2 (112) can include high-speed broadband Internet type communications systems. It is important to note that the content from the broadcast affiliate manager 104 can also be delivered using all or parts of delivery network 2 (112) and content from the content manager 110 can be delivered using all or parts of Delivery network 1 (106). In addition, the user can also obtain content directly from the Internet via delivery network 2 (112) without necessarily having the content managed by the content manager 110. In addition, the scope of the search goes beyond available content to content that can be broadcast or made available in the future.

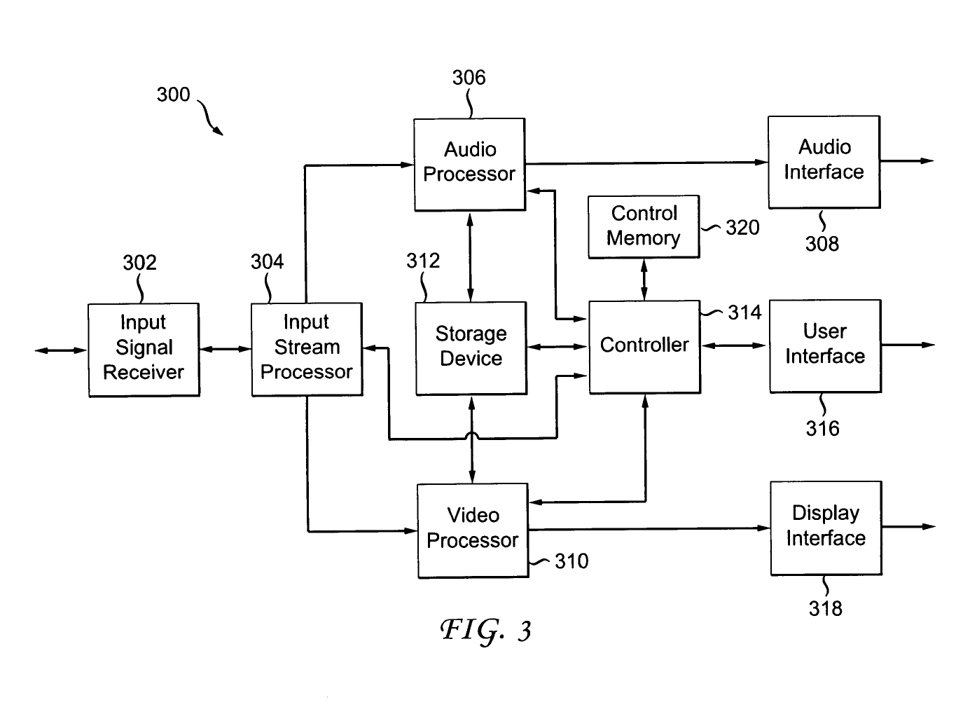

The set top box/digital video recorder 108 can receive different types of content from one or both of delivery network 1 and delivery network 2. The set top box/digital video recorder 108 processes the content, and provides a separation of the content based on user preferences and commands. The set top box/digital video recorder can also include a storage device, such as a hard drive or optical disk drive, for recording and playing back audio and video content. Further details of the operation of the set top box/digital video recorder 108 and features associated with playing back stored content will be described below in relation to FIG. 3. The processed content is provided to a display device 114. The display device 114 can be a conventional 2-D type display or can alternatively be an advanced 3-D display. It should be appreciated that other devices having display capabilities such as wireless phones, PDAs, computers, gaming platforms, remote controls, multi-media players, or the like, can employ the teachings of the present disclosure and are considered within the scope of the present disclosure.

Delivery network 2 is coupled to an online social network 116 which represents a website or server in which provides a social networking function. For instance, a user operating set top box 108 can access the online social network 116 to access electronic messages from other users, check into recommendations made by other users for content choices, see pictures posted by other users, refer to other websites that are available through the “Internet Content” path.

Online social network server 116 can also be connected with content manager 110 where information can be exchanged between both elements. Media that is selected for viewing on set top box 108 via content manager 110 can be referred to in an electronic message for online social networking 116 from this connection. This message can be posted to the status information of the consuming user who is viewing the media on set top box 108. That is, a user using set top box 108 can instruct that a command be issued from content manager 110 that indicates information such as the <<ASSETID>>, <<ASSETTYPE>>, and <<LOCATION>> of a particular media asset which can be in a message to online social networking server 116 listed in <<SERVICE ID>> for a particular user identified by a particular field <<USERNAME>> is used to identify a user. The identifier can be an e-mail address, hash, alphanumeric sequence, and the like . . . .

Content manager 110 sends this information to the indicated social networking server 116 listed in the <<SERVICE ID>>, where an electronic message for &USERNAME has the information comporting to the <<ASSETID>>, <<ASSETTYPE>>, and <<LOCATION>> of the media asset posted to status information of the user. Other users who can access the social networking server 116 can read the status information of the consuming user to see what media the consuming user has viewed.

Examples of the information of such fields are described below.

TABLE 1

| | |
|---|---|
| <<SERVICE ID> | This field represents a particular social networking |
| | service or other messaging medium that can be used. |
| &FACEBOOK | Facebook |
| &TWITTER | Twitter |
| &LINKEDIN | Linked-In |
| &FLICKER | Flicker Photo Sharing |
| &QZONE | Q-Zone |
| &MYSPACE | MySpace |
| &BEBO | Bebo |
| &SMS | Text Messaging Service |
| &USERNAME | User Name of a person using a social networking |
| | service |

TABLE 2

| | |
|---|---|
| <<ASSETID>> | This field represents the “name” of the media |
| | asset which is used for identifying the particular |
| | asset |
| &UUID | A universal unique identifier that is used for the |
| | media asset. This can be a unique MD5, SHA1, |
| | other type of hash, or other type of identifier |
| &NAME | A text name for the media asset |
| &TIME | Time that a media asset is being accessed. This |
| | information can be seconds, hours, days, day of |
| | the week, date, and other time related information |
| &ASSETCOMPLETE | The % of completion in the consumption of an |
| | asset |

The term media asset (as described below for TABLE 3) can be: a video based media, an audio based media, a television show, a movie, an interactive service, a video game, a HTML based web page, a video on demand, an audio/video broadcast, a radio program, advertisement, a podcast, and the like.

TABLE 3

| | |
|---|---|
| <<ASSETTYPE> | This field represents the type of asset that is |
| | being communicated to a user of a |
| | social networking website. |
| &VIDEO | Video based asset |
| &AUDIO | Audio based asset |
| &PHOTO | Photo based asset |
| &TELEVISION | Television show asset which can be audio, video, |
| | or a combination of both |
| &MOVIE | Movie asset which can be audio, video, or a |
| | combination of both |
| &HTML | HTML based web page |
| &PREVIEW | Trailer which can be audio, video, or a combination |
| | of both |
| &ADMOVE | Advertisement asset - expected to be video and/or |
| | audio based such as a flash animation, |
| | H.264 video, SVC video, and the like. |
| &ADSTAT | Advertisement asset - expected to be a static image |
| | such as a JPG, PNG, and the like that can be |
| | used as a banner ad |
| &TEXT | Text Message |
| &RADIO | An audio asset that comes from terrestrial and/or |
| | satellite radio |
| &GAME | Game asset. |
| &INTERACTIVE | An interactive based media asset |
| &PODCAST | Podcast that is audio, video, or a combination of both |
| &APPLICATION | Indicates that a user utilized a particular type of |
| | application or accessed a particular service |

TABLE 4

| | |
|---|---|
| <<LOCATION> | This field represents the location of a particular |
| | media asset |
| &URL | The location of a media asset expressed as a uniform |
| | resource locator and/or IP address |
| &PATH\PATH . . . | The location of a media asset expressed as a |
| | particular local or remote path which can have |
| | multiple subdirectories. |
| &REMOTE | The location of a media asset in a remote location |
| | which would be specified by text after the remote |
| | attribute. |
| &LOCAL | The location of a media asset in a local location |
| | which would be specified by text after the |
| | remote attribute. |
| &BROADCAST | The location being a broadcast source such as |
| | satellite, broadcast television channel, cable channel, |
| | radio station, and the like |
| &BROADCASTID | The identifier of the broadcast channel used for |
| | transmitting a media asset, and the like |
| &SERVICE | Identification of a service for which a media asset |
| | can originate (as a content source or content |
| | provider). Examples of different services include |
| | HULU, NETFLIX, VUDU, and the like. |

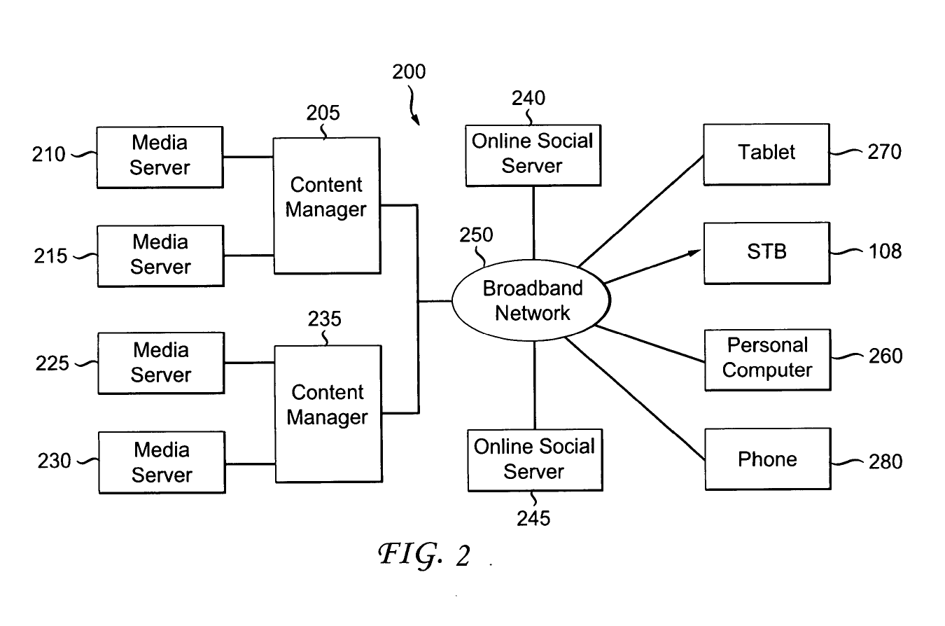

FIG. 2 presents a block diagram of a system 200 that presents an arrangement of media servers, online social networks, and consuming devices for consuming media. Media servers 210, 215, 225, and 230 represent media servers where media is stored. Such media servers can be a hard drive, a plurality of hard drives, a server farm, a disc based storage device, and other type of mass storage device that is used for the delivery of media over a broadband network.

Media servers 210 and 215 are controlled by content manager 205. Likewise, media server 225 and 230 are controlled by content manager 235. In order to access the content on a media server, a user operating a consumption device such as STB 108, personal computer 260, table 270, and phone 280 can have a paid subscription for such content. The subscription can be managed through an arrangement with the content manager 235. For example, content manager 235 can be a service provider, and a user who operates STB 108 has a subscription to programming from a movie channel and to a music subscription service where music can be transmitted to the user over broadband network 250. Content manager 235 manages the storage and delivery of the content that is delivered to STB 108. Likewise, other subscriptions can exist for other devices such as personal computer 260, tablet 270, and phone 280, and the like. It is noted that the subscriptions available through content manager 205 and 235 can overlap, where for example; the content comporting for a particular movie studio such as DISNEY can be available through both content managers. Likewise, both content managers 205 and 235 can have differences in available content, as well, for example content manager 205 can have sports programming from ESPN while content manager 235 makes available content that is from FOXSPORTS. Content managers 205 and 235 can also be content providers such as NETFLIX, HULU, and the like who provide media assets where a user subscribes to such a content provider. An alternative name for such types of content providers is the term over the top service provider (OTT) which can be delivered “on top of” another service. For example, considering FIG. 1 content manager 110 provides internet access to a user operating set top box 108. An over the top service from content manager 205/235 (as in FIG. 2) can be delivered through the “internet content” connection, from content source 102, and the like.

A subscription is not the only way that content can be authorized by a content manager 205, 235. Some content can be accessed freely through a content manager 205, 235 where the content manager does not charge any money for content to be accessed. Content manager 205, 235 can also charge for other content that is delivered as a video on demand for a single fee for a fixed period of viewing (number of hours). Content can be bought and stored to a user's device such as STB 108, personal computer 260, tablet 270, and the like where the content is received from content managers 205, 235. Other purchase, rental, and subscription options for content managers 205, 235 can be utilized as well.

Online social servers 240, 245 represent the servers running online social networks that communicate through broadband network 250. Users operating a consuming device such as STB 108, personal computer 260, tablet 270, and phone 280 can interact with the online social servers 240, 245 through the device, and with other users. One feature about a social network that can be implemented is that users using different types of devices (PCs, phones, tablets, STBs) can communicate with each other through a social network. For example, a first user can post messages to the account of a second user with both users using the same social network, even though the first user is using a phone 280 while a second user is using a personal computer 260. Broadband network 250, personal computer 260, tablet 270, and phone 280 are terms that are known in the art. For example, a phone 280 can be a mobile device that has Internet capability and the ability to engage in voice communications.

Turning now to FIG. 3, a block diagram of an embodiment of the core of a set top box/digital video recorder 300 is shown, as an example of a consuming device. The device 300 shown can also be incorporated into other systems including the display device 114. In either case, several components necessary for complete operation of the system are not shown in the interest of conciseness, as they are well known to those skilled in the art.

In the device 300 shown in FIG. 3, the content is received in an input signal receiver 302. The input signal receiver 302 can be one of several known receiver circuits used for receiving, demodulating, and decoding signals provided over one of the several possible networks including over the air, cable, satellite, Ethernet, fiber and phone line networks. The desired input signal can be selected and retrieved in the input signal receiver 302 based on user input provided through a control interface (not shown). The decoded output signal is provided to an input stream processor 304. The input stream processor 304 performs the final signal selection and processing, and includes separation of video content from audio content for the content stream. The audio content is provided to an audio processor 306 for conversion from the received format, such as compressed digital signal, to an analog waveform signal. The analog waveform signal is provided to an audio interface 308 and further to the display device 114 or an audio amplifier (not shown). Alternatively, the audio interface 308 can provide a digital signal to an audio output device or display device using a High-Definition Multimedia Interface (HDMI) cable or alternate audio interface such as Via a Sony/Philips Digital Interconnect Format (SPDIF). The audio processor 306 also performs any necessary conversion for the storage of the audio signals.

The video output from the input stream processor 304 is provided to a video processor 310. The video signal can be one of several formats. The video processor 310 provides, as necessary a conversion of the video content, based on the input signal format. The video processor 310 also performs any necessary conversion for the storage of the video signals.

A storage device 312 stores audio and video content received at the input. The storage device 312 allows later retrieval and playback of the content under the control of a controller 314 and also based on commands, e.g., navigation instructions such as fast-forward (FF) and rewind (Rew), received from a user interface 316. The storage device 312 can be a hard disk drive, one or more large capacity integrated electronic memories, such as static random access memory, or dynamic random access memory, or can be an interchangeable optical disk storage system such as a compact disk drive or digital video disk drive. In one embodiment, the storage device 312 can be external and not be present in the system.

The converted video signal from the video processor 310, either originating from the input or from the storage device 312, is provided to the display interface 318. The display interface 318 further provides the display signal to a display device of the type described above. The display interface 318 can be an analog signal interface such as red-green-blue (RGB) or can be a digital interface such as high definition multimedia interface (HDMI). It is to be appreciated that the display interface 318 will generate the various screens for presenting the search results in a three dimensional array as will be described in more detail below.

The controller 314 is interconnected via a bus to several of the components of the device 300, including the input stream processor 302, audio processor 306, video processor 310, storage device 312, and a user interface 316. The controller 314 manages the conversion process for converting the input stream signal into a signal for storage on the storage device or for display. The controller 314 also manages the retrieval and playback of stored content. Furthermore, as will be described below, the controller 314 performs searching of content, either stored or to be delivered via the delivery networks described above. The controller 314 is further coupled to control memory 320 (e.g., volatile or non-volatile memory, including random access memory, static RAM, dynamic RAM, read only memory, programmable ROM, flash memory, EPROM, EEPROM, etc.) for storing information and instruction code for controller 214. Further, the implementation of the memory can include several possible embodiments, such as a single memory device or, alternatively, more than one memory circuit connected together to form a shared or common memory. Still further, the memory can be included with other circuitry, such as portions of bus communications circuitry, in a larger circuit.

To operate effectively, the user interface 316 of the present disclosure employs an input device that moves a cursor around the display, which in turn causes the content to enlarge as the cursor passes over it. In one embodiment, the input device is a remote controller, with a form of motion detection, such as a gyroscope or accelerometer, which allows the user to move a cursor freely about a screen or display. In another embodiment, the input device is controllers in the form of touch pad or touch sensitive device that will track the user's movement on the pad, on the screen. In another embodiment, the input device could be a traditional remote control with direction buttons.

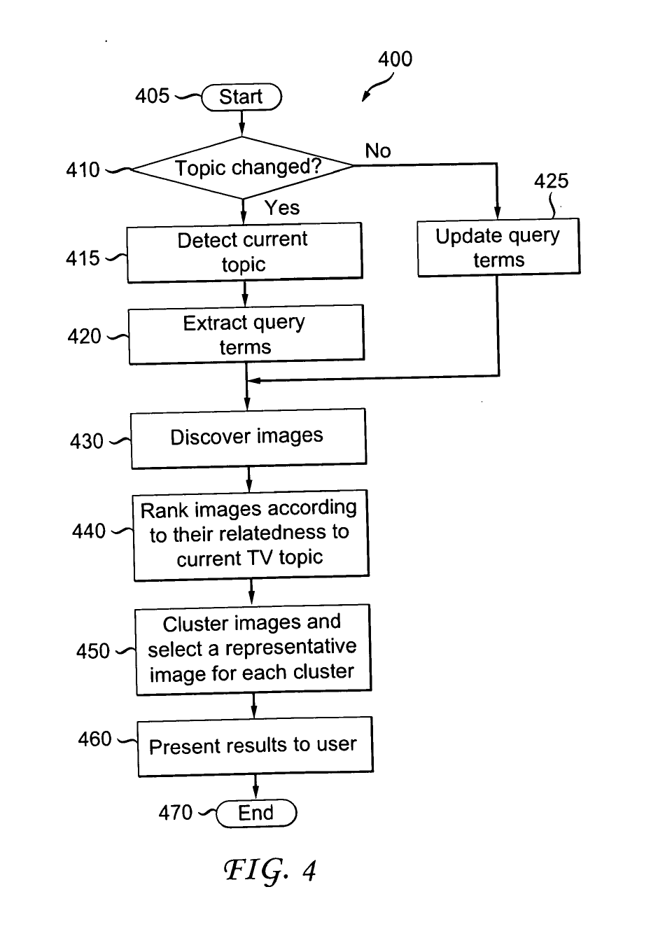

FIG. 4 describes a method 400 for obtaining topics that are associated with a media asset. The method starts with step 405. The method begins by extracting keywords from auxiliary information associated with a media asset (step 410). However, unlike other keyword extraction techniques, this is not the final processing for this method. One approach can use a closed captioning processor (in a set top box 108, in a content manager 205/235, or the like) which processes or reads in the EIA-608/EIA-708 formatted closed captioning information that is transmitted with a video media asset. The closed captioning processor can have a data slicer which outputs the captured closed caption data as an ASCII text stream.

It is noted that different broadcast sources can be arranged differently, where the closed captioning and other types of auxiliary information can be configured to extract the data of interest depending on the way how the data stream is configured. For example, an MPEG-2 transport stream that is formatted for broadcast in the United States using an ATSC format is different than the digital stream that is used for a DVB-T transmission in Europe, and different than an ARIB based transmission that is used in Japan.

In step 415, this step begins with the outputted text stream being processed in step to produce a series of keywords which are mapped to topics. That is, the outputted text stream is formatted into a series of sentences.

### Keyword Extraction

In one embodiment, two types of keywords are focused on: named entities and meaningful, single word or multi-word phrases. For each sentence, named entity recognition is first used to identify all named entities, e.g. people's name, location name, etc. However, there are also pronouns in closed caption e.g. “he”, “she”, “they”. Thus, name resolution is applied to resolve pronouns to the full name of the named entities they refer to. Then, for all the n-grams (other than named entities) of a closed caption sentence, databases such as Wikipedia can be used as a dictionary to find meaningful phrases. For each candidate phrase of length greater than one, if it starts or ends with a stopword, it is removed. The use of Wikipedia can eliminate certain meaningless phrases, e.g. “is a”, “this is”.

### Resolving Surface Forms

Many phrases have different forms. For example “leaf cutter ant”, “leaf cutter ants”, leaf-cutter ant”, “leaf-cutter ants” all refer to the same thing. If any of these phrases is a candidate, the correct form must be found. The redirect page in databases such as Wikipedia can used to solve this problem. In Wikipedia, “leaf cutter ant”, “leaf cutter ants”, leaf-cutter ant”, “leaf-cutter ants” all redirect to a single page titled: “leafcutter ant”. Given a phrase, all the redirect page title and the target page title as candidate phrases can be used.

### Additional Stopword Lists

Two lists of stopwords known as the academic stopwords list and the general service list can also be used. These terms can be combined with the existing stopwords list to remove phrases that are too general and thus cannot be used to locate relevant images.

### Selecting Keywords According to Database Attributes

Several attributes can be associated with each database entry. For example, each Wikipedia article can have these attributes associated with it: number of incoming links to a page, number of outgoing links, generality, number of ambiguations, total number of times the article title appears in the Wikipedia corpus, number of times it occurs as a link etc.

It was observed that for most of the specific terms, the value of most of the attributes was very less compared to the values of those terms which were considered as too general. Accordingly, a set of specific or significant terms is used and their attribute values chosen to set a threshold. Then, those terms whose feature values did not fall in this threshold are considered as noise terms and are neglected. A filtered ngram dictionary is created out of the terms whose feature values are below the threshold. This filtered ngram is used to process the closed captions and to find the significant terms in a closed captioned sentence.

### Selecting Keywords According to Category

When the candidate phrases fall into a certain category, e.g. “animal”, further filtering can be performed. A thorough investigation was performed on the Wordnet package. If a word, for example “python” is given to this package, it will return all the possible senses for the word “python” in English language. So for python the possible senses are: “reptile, reptilian, programming language”. Then these senses can be compared with the context terms for a match.

In one embodiment, the Wikipedia approach is combined with this wordnet approach. So once a closed captioned sentence is obtained, the line is processed, the ngrams are found and the ngrams are checked to determine whether the ngrams belong to the Wikipedia corpus and if they belonged to the wordnet corpus. In testing this approach, a considerable success could be achieved in obtaining most of the significant terms in the closed captioning. One problem with this method was that wordnet provides senses only for words but not for keyphrases. So, for example, “blue whale”, will not get any senses because it is a keyphrase. A solution to this problem was found by taking only the last term in a keyphrase and checking for their senses in wordnet. So if a search is performed for the senses of “whale” in wordnet, it can be identified that it belongs to the current context and thus “blue whale” will not be avoided.

### Selecting Keywords According to Sentence Structure

For many sentences in closed captioning, the subject phrases are very important. As such, a dependency parser can be used to find the head of a sentence and if the head of the sentence is also a candidate phrase, the head of the sentence can be given a higher priority.

### Selecting Keywords Based on Semantic Relatedness

The named entities, term phrases might represent different topics not directly related to the current TV program. Accordingly, it is necessary to determined which term phrases are more relevant. After processing several sentences, semantic relatedness is used to cluster all terms together. The cluster with the most density is then determined. Terms in this cluster can be used for related image query.

The keywords are further processed in step 420 by mapping extracted keywords to a series of topics (as query terms) by using a predetermined thesaurus database that associates certain keywords with a particular topic. This database can be set up where a limited selection of topics are defined (such as particular people, subjects, and the like) and various keywords are associated with such topics by using a comparator that attempts to map a keyword against a particular subject. For example, a thesaurus database (such as WordNet and the Yahoo OpenDirectory project) can be set up where the keywords such as money, stock, market, are associated with the topic “finance”. Likewise, keywords such as President of the United States, 44th President, President Obama, Barack Obama, are associated with the topic “Barack Obama”. Other topics can be determined from keywords using this or similar approaches for topic determination. Another method for doing this could use Wikipedia or a similar knowledge base where content is categorized based on topics. Given a keyword that has an associated topic in Wikipedia, a mapping of keyword to topics can be obtained for the purposes of creating as thesaurus database, as described above.

Once such topics are determined for each sentence, such sentences can be represented in the form of: <topic_{—}1:weight_{—}1;topic_{—}2;weight_{—}2, . . . ,topic_n,weightN,ne_{—}1,ne_{—}2, . . . ,ne_m>.

Topic_i is the topic that is identified based on the keywords in a sentence, weight_i is a corresponding relevance, Ne_i is the named entity that is recognized in the sentence. Named entities refer to people, places and other proper nouns in the sentence which can be recognized using grammar analysis.

It is possible that some entity is mentioned frequently but is indirectly referenced through the use of pronouns such as “he, she, they”. If each sentence is analyzed separately such pronouns will not be counted because such words are in the stop word list. The word “you” is a special case as in that is used frequently. The use of name resolution will help assign the term “you” to a specific keyword/topic referenced in a previous/current sentence. Otherwise, “you” will be ignored if it can't be referenced to a specific term. To resolve this issue the name resolution can be done before the stop word removal.

If several sentences discuss the same set of topics and mention the same set of named entities, an assumption is made that the “current topic” of a series of sentences is currently being referenced. If a new topic is referenced over a new set of sentences, it is assumed that a new topic is being addressed. It is expected that topics will change frequently over the course of a video program.

These same principles can also be applied to receipt of a Really Simple Syndication (RSS) feed that is received by a user's device, which is typically “joined” by a user. These feeds typically represent text and related tags, where the keyword extraction process can be used to find relevant topics from the feed. The RSS feed can be analyzed to return relevant search results by using the approaches described below. Importantly, the use of both broadcast and RSS feeds can be done at the same time by using the approaches listed within this specification.

### Topic Change Detection

When the current TV topic is over and a new topic starts, this change needs to be detected so that relevant images can be retrieved based on the new topic. Failure to detect this change can result in non-matching between old query results and the new topic, which confuses viewers. Premature detection can result in unnecessary processing.

When a current topic is over (405) and a new topic starts, such a change is detected by using a vector of keywords over a period of time. For example, in a news broadcast, many topics are discusses such as sports, politics, weather, etc. As mentioned previously, each sentence is represented as a list of topic weights (referred to as a vector). It is possible to compare the similarity of consecutive sentences (or alternatively between two windows containing a fixed number of words). There are many known similarity metrics to compare vectors, such as cosine similarity or using the Jaccard index. From the generation of such vectors, the terms can be compared and similarity is performed which notes the differences between such vectors. These comparisons are performed over a period of time. Such a comparison helps determine how much of change occurs from topic to topic, so that a predefined threshold can be determined where if the “difference” metric, depending on the technique used, exceeds the threshold, it is likely that the topic has changed.

As an example of this approach, a current sentence is checked against a current topic by using a dependency parser. Dependency parsers process a given sentence and determine the grammatical structure of the sentence. These are highly sophisticated algorithms that employ machine learning techniques in order to accurately tag and process the given sentence. This is especially tricky for the English language due to many ambiguities inherent to the language. First, a check is performed to see if there are any pronouns in a sentence. If so, the entity resolution step is performed to determine which entities are mentioned in a current sentence. If no pronouns are used and if no new topics are found, it is assumed that the current sentence refers to the same topic as previous sentences. For example, if “he/she/they/his/her” is in a current sentence, it is likely that such terms refer to an entity from a previous sentence. It can be assumed that the use of such pronouns will have a current sentence refer to the same topic as a previous sentence. Likewise, for the following sentence, it can be assumed that the use of a pronoun in the sentence refers to the same topic as the previous sentence.

For the current topic, the most likely topic and most frequently mentioned entity is kept. Then the co-occurrence of topic and entity can be used to detect the change of topic. Specifically, a sentence is used if there is at least one topic and one entity recognized for it. The topic is changed if there are a certain number of consecutive sentences whose <topic_{—}1, topic_{—}2, . . . topic_n, ne_{—}1, ne_{—}2, ne_m> do not cover the current topic and entity. Choosing a large number might give a more accurate detection of topic change, but at the cost of increased delay. The number 3 was chosen for testing.

A change (step 405) between topics is noted when there is a change between the vectors of consecutive sentences, where the difference between two vectors varies by a significant difference. Such a difference can be changed in various embodiments, but it is noted that a large number (in a difference) can be more accurate in detecting a topic change, but using a large number imparts a longer delay of the detection of topics. A new query can be submitted with this new topic in step 425.

### Image Discovery

After extracting meaningful terms, the meaningful terms can be used to query image repository sites, e.g. Flickr, to retrieve images tagged with these terms (step 430). However, the query results often contain some images that are not related to the current program. One solution to getting rid of these images which are not relevant to the current context is to check whether the tags of a result image belong to the current context. For each program, a list of context terms is created which are the most general terms related to it. For example, a term list can be created for contexts like nature, wildlife, scenery and animal kingdom. So once the images that are tagged with a keyphrase are obtained, it can be checked whether any of the tags of the image matched the current context or the list of context terms. Only those images for which a match was found are added to the list of related images.

The query approach only gives images that are explicitly tagged with matching terms. Related images with other terms cannot be retrieved. A co-occurrence approach can be used for image discovery. The intuition is, if several images occur together in the same page which discusses the same topic or they are taken by the same photographer on very similar subject, they are related. If a user likes one of them, it is likely that the user will like other images, even if other images are tagged using different terms. The image discovery step finds all image candidates that are possibly related to the current TV program.

Each web document is represented as a vector: (For a web page, it is usually necessary to remove noisy data, e.g. advertisement text)
D=<IMG₁, TXT₁, IMG₂, TXT₂, . . . IMGₙ, TXTₙ>
   The pure text representation of this document is:
Dₜₓₜ=<TXT₁, TXT₂, . . . , TXTₙ>

Where IMG; is an image embedded in the page, TXTᵢ is the corresponding text description of this image. The description of an image can be its surrounding text, e.g. text in the same HTML element (div). It can also be the tags assigned to this image. If the image links to a separate page showing a larger version of this image, the title and text of the new page are also treated as the image description.

Similarly, each photographer's photo collection is represented as:
Pᵤ=<IMG₁, TXT₁, IMG₂, TXT₂, . . . IMGₙ, TXTₙ>

Where IMG; is an image taken by photographer u, TXTᵢ (1<=i<=n) is the corresponding text description of this image.

The pure text representation of this photographer is:
P_{u,txt}=<TXT₁, TXT₂, . . . , TXTₙ>

Suppose the term extraction stage extracts a term vector <T₁ T₂ . . . Tₖ>. These extracted terms can be used to query the text representation of web pages and photographer collections. The resulting images contained in the web pages or taken by the same photographer will be chosen as candidates.

### Image Recommendation

The image discovery step will discover all images that co-occur in the same page or are taken by the same photographer. However, some co-occurring or co-taken images might be about quite different topics than the current TV program. If these images are recommended, users might get confused. Therefore, those images that are not related are removed.

For each candidate image, its text description is compared with the current context. Semantic relatedness can be used to measure the relevancy between current TV closed caption and image description. Then all images are ranked according to their semantic distance with the current context in step 440. Semantically related images will be ranked higher.

The top ranking images are semantically related to the current TV context. However, the images can be of different interest to users, because of their image quality, visual effects, resolution, etc. Therefore, not all semantically related images are interesting to users. Thus step 440 includes further ranking of these semantically relevant images.

The first ranking approach is to use the comments made by regular users for each of the semantically related image. The number of comments for an image often shows how popular the image is. The more comments an image has, the more interesting it might be. This is especially true if most comments are positive. The simplest approach is to use the number of comments to rank images. However, if most of the comments are negative, a satisfactory ranking cannot be achieved. The polarity of each comment needs to be taken into account. For each comment, sentiment analysis can be used to find whether the user is positive or negative about it. It is likely that a popular image can get hundreds of comments, while an unpopular image might have less than a few comments. A configurable number, for example 100, can be specified as the threshold for scaling the rating. Only the positive ratings are counted and the score is limited to the range between 0 and 1. It is defined as:

$$IR = \{ \begin{matrix}\frac{\# of positive ratings}{Total \# of ratings} & if total \# of ratings \geq 100 \\ \frac{\# of positive ratings}{100} & if total \# of ratings < 100\end{matrix}$$

Another ranking approach is to use the average rating of the photographer. The higher a photographer is rated, the more likely users will like his/her other images. The rating of a photographer can be calculated by averaging all the images taken by this photographer.

It is likely that some images do not have a known photographer and they do not have comments, either because the web site does not allow user comments or because they are just uploaded and not viewed by many users. A third ranking approach is to use the image color histogram distribution, because human eyes are more sensitive to variation of colors. First, a group of popular images is elected and their color histogram information is extracted. Then the common properties of the majority of these images are found. For a newly discovered image, its distance from the common properties is calculated. Then the most similar images are selected for recommendation.

### Diversification

There is a possibility that the top-N images matching the current context are quite similar to each other. Most users like a variety of images instead of a single type. In order to diversify the results, the images are clustered according to their similarity to each other and the highest ranking one from each cluster is recommended in step 450. Image clustering can be done using description text, such that images with very similar description will be put into the same cluster.

### Performance Consideration

Ranking images requires extensive operation on the whole data set. However, some features do not change frequently. For example, if a professional photographer is already highly rated, his/her rating can be cached without re-calculating each time. If a photo is already highly rated with many comments, e.g. more than 100 positive comments, its rating can also be cached. Moreover, for newly uploaded pictures or new photographers, their rating can be updated periodically and the results cached.

The selected representative image is then present to the user in step 460. At which point the depicted method of FIG. 4 ends (step 470).

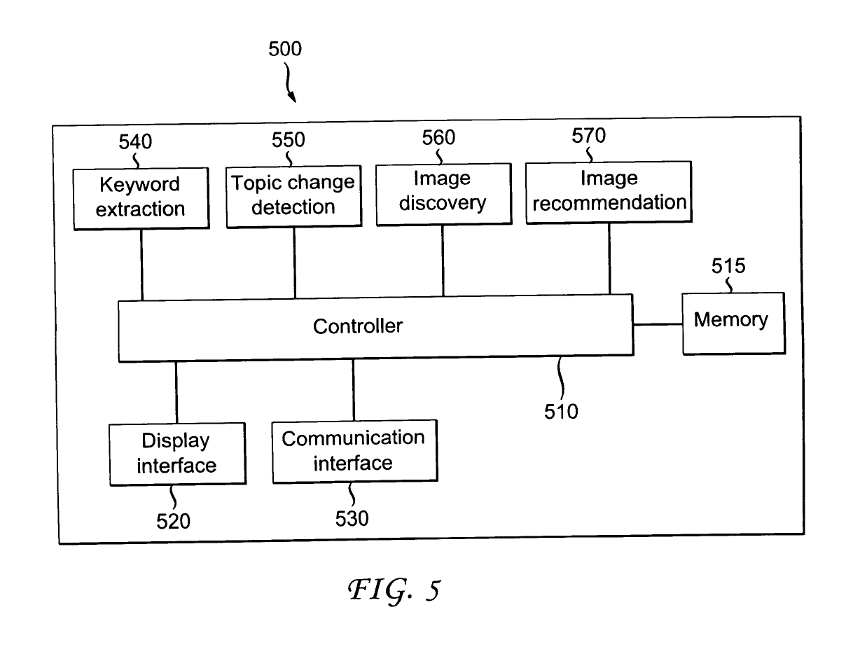

FIG. 5 depicts a block diagram 500 of a simplified configuration of the components that could be used to perform the methodology set forth above. The components include a controller 510 and memory 515, a display interface 520, a communication interface 530, a keyword extraction module 540, topic change detection module 550, and image discovery module 560 and an image recommendation module 570. Each of these will be discussed in more detail below.

The controller 510 is in communication with all the other components and serves to control the other components. The controller 510 can be the same controller 314 as described in regard to FIG. 3, a subset of the controller 314, or a separate controller altogether.

The memory 515 is configured to store the data used by the controller 510 as well as the code executed by the controller 510 to control the other components. The memory 510 can be the same memory 320 as described in regard to FIG. 3, a subset of the memory 320, or a separate memory altogether.

The display interface 520 handles the output of the image recommendation to the user. As such, it is involved in the performing of step 460 of FIG. 4. The display interface 520 can be the same display interface 316 as described in regard to FIG. 3, a subset of the display interface 316, or a separate display interface altogether.

The communication interface 530 handles the communication of the controller with the internet and the user. The communication interface 530 can be the input signal receiver 302, or user interface 316 as described in regard to FIG. 3, a combination of both, a subset of either, or a separate communication interface altogether.

The keyword extraction module 540 performs the functionality described in relation to steps 420 and 425 in FIG. 4. The keyword extraction module 540 can be implemented in software, hardware, or a combination of both.

The topic change detection module 550 performs the functionality described in relation to steps 410 and 415 in FIG. 4. The topic change detection module 550 can be implemented in software, hardware, or a combination of both.

The image discovery module 560 performs the functionality described in relation to step 430 in FIG. 4. The image discovery module 560 can be implemented in software, hardware, or a combination of both.

The image recommendation module 570 performs the functionality described in relation to steps 440 and 450 in FIG. 4. The image recommendation module 570 can be implemented in software, hardware, or a combination of both.

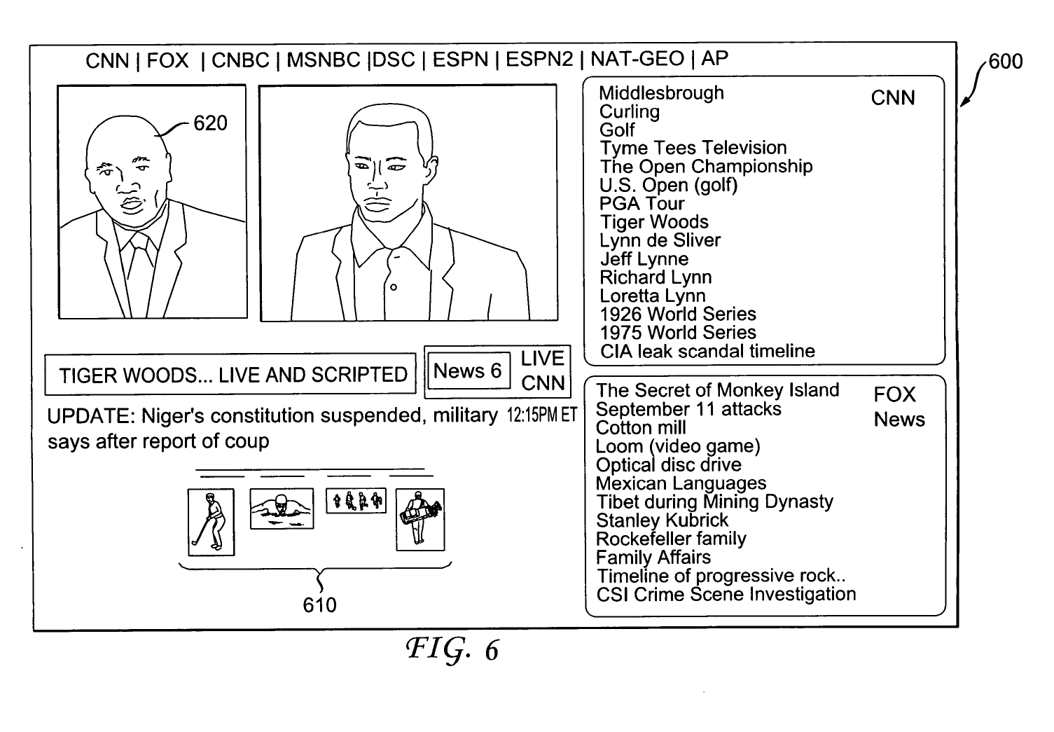

FIG. 6. depicts an exemplary screen capture 600 displaying discovered images 610 related to the topic of the program being displayed 620. In this embodiment, the images 610 are representative images of image clusters of multiple found related images. As can be seen in the screen capture 600, the program being displayed 620 is a CNN report about the golfer Tiger Woods. As such, the recommended found images 610 are golf related.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for performing automatic image discovery for displayed content, the method comprising:
detecting a topic of the displayed content;
extracting query terms based on the detected topic;
discovering images based on the query terms; and
displaying one or more the discovered images.

2. The method of claim 1, further comprising:
detecting if the topic has changed; and
updating the query terms.

3. The method of claim 1, wherein the step of detecting the topic of content being displayed comprises:
processing the closed captioning provided with the content being displayed.

4. The method of claim 1, wherein the step of extracting query terms based on the detected topic comprises:
extracting keywords based on named entities and meaningful phrases.

5. The method of claim 4, wherein keyword extraction comprises one or more of:
selecting keywords based on category;
selecting keywords based on sentence structure; and
selecting keywords based on semantic relatedness.

6. The method of claim 4, wherein keyword extraction comprises:
consulting a database to determine meaningful phrases.

7. The method of claim 1, wherein the step of extracting query terms based on the detected topic further comprises:
Resolving surface forms for a candidate phrase.

8. The method of claim 1 further comprising:
ranking the discovered images according to relatedness to the topic.

9. The method of claim 1 wherein the step of discovering images based on the query terms comprises:
searching online image databases.

10. The method of claim 1 further comprising:
clustering related images;
selecting a representative image for each cluster;

11. A system for performing automatic image discovery for displayed content, the system comprising:
a topic detection module configured to detect a topic of the displayed content;
a keyword extraction module configured to extract query terms from the detected topic;
an image discovery module configured to discover images based on query terms; and
a controller configured to control the topic detection module, keyword extraction module, and image discovery module.

12. The system of claim 11 further comprising:
a display interface configured to display one or more of the discovered images.

13. The system of claim 11 further comprising:
a memory configured to store data and instruction for the controller; and
a communication interface configured to interface the controller with the internet and the user.

14. A computer program product comprising a computer useable medium having a computer readable program, wherein the computer readable program when executed on a computer causes the computer to perform method steps including:
performing automatic image discovery for displayed content, the method comprising:
detecting the topic of the content being displayed;
extracting query terms based on the detected topic;
discovering images based on the query terms; and
displaying one or more the discover images.
